(19) United States
(12) Patent Application Publication
(10) Pub. No.: US 2025/0358556 A1
(43) Pub. Date: Nov. 20, 2025

(54) SYSTEMS AND METHODS RELATED TO SPEAKER PLATFORMS

(71) Applicant: JOHN WOLFF, HELENVILLE, WI (US)

(72) Inventor: JOHN WOLFF, HELENVILLE, WI (US)

(21) Appl. No.: 18/666,406

(22) Filed: May 16, 2024

(51) Int. Cl. H04R 1/02; A47C 4/02; A47C 7/72

(52) U.S. Cl. CPC H04R 1/025; A47C 4/02; A47C 7/727; H04R 1/026; H04R 2420/07

(57) ABSTRACT

Systems according to the present invention generally include top, base, and side panels enclosing a plurality of speakers. A center panel divides the inner chamber into two sealed chambers. When the speakers play audio, the sound waves cause the top and base panels to flex, creating vibrations that may be felt by anyone standing or sitting on the top panel. Some embodiments of the systems may also include a chair mount, into which the spindle or post of a chair may be installed. Methods according to the present invention may comprise providing a system as described above for an enhanced audio experience and playing music through the speakers while a user is supported by the system.

### BACKGROUND

As many music listeners and performers may explain, music is not something you just listen to, but something you have to feel. Deep vibrations and rhythms expand and deepen the musical experience of everyone involved, not matter if you are on a stage, in a crowd, or listening or playing on your own.

Generally, these vibrations are created through pressure differentials created by speakers. For musicians especially, these vibrations are key. Even when the particular notes of the music itself is indiscernible, the vibrations that they feel help them keep time and not get lost in the sea of sound. Yet, musicians and music listeners are not the only people who benefit from these types of vibrations.

To many individuals, such as those in the deaf and hard-of-hearing communities, vibrations of sound are one of the primary ways to experience music. Deep base notes and drum beats create heavy vibrations that are easy to feel through physical sensation. This experience may also differ depending on how a person feels the vibrations, such as through their feet through concrete or grass, through their hands by playing them on a speaker, or through their ear muscles from headphones.

Vibrations may also aid in experiences outside of music. For instance, moviegoers know well the feeling of a deep bass vibration running through them at a climactic moment. Further, video game players rely on sounds and vibrations in many situations to give them information regarding their surroundings or to simply add to story beats such as with a movie. For all of these groups, sound vibrations are key to a full auditory experience. Therefore, improved systems and methods for experiencing enhanced auditory vibrations are desired.

### SUMMARY OF THE INVENTION

The present invention relates generally to improved designs in speaker-integrated platforms. Specifically, the present invention relates to a speaker-integrated platform having dual enclosed chambers surrounded by flexible panels, wherein air pressure differentials from the speakers create vibrations that drive platform flexing.

### BRIEF DESCRIPTION OF THE DRAWINGS

FIG. 1 is a perspective view of a system according to the present invention.

FIG. 2 is a perspective view of the system of FIG. 1 without the attached chair.

FIG. 3 is a top plan view of the system of FIG. 1.

FIG. 4 is a bottom plan view of the system of FIG. 1.

FIG. 5 is a cross-sectional view taken along the 5-5 line of FIG. 3.

### DETAILED DESCRIPTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

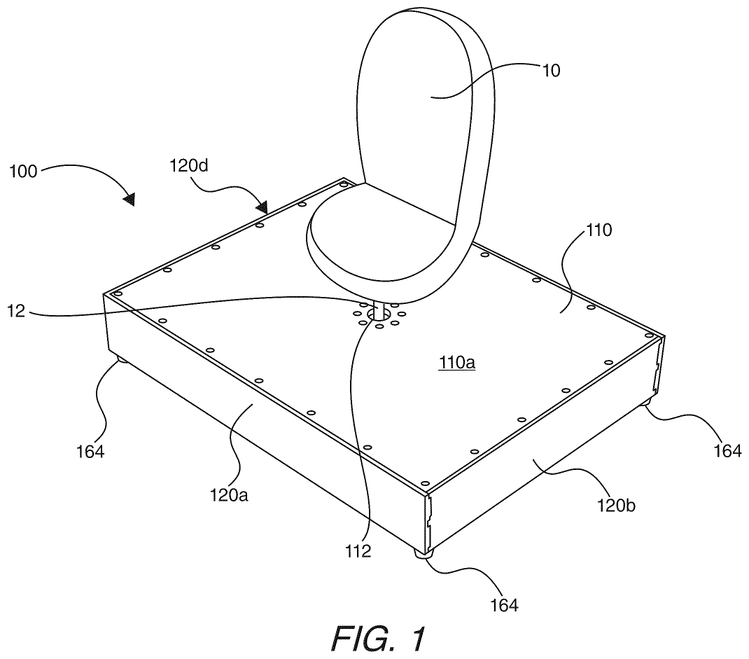

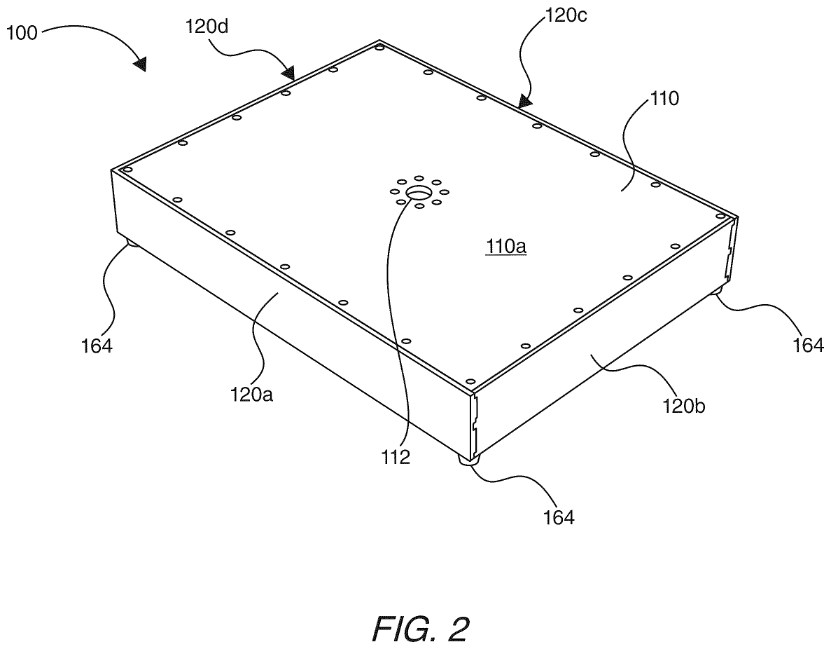

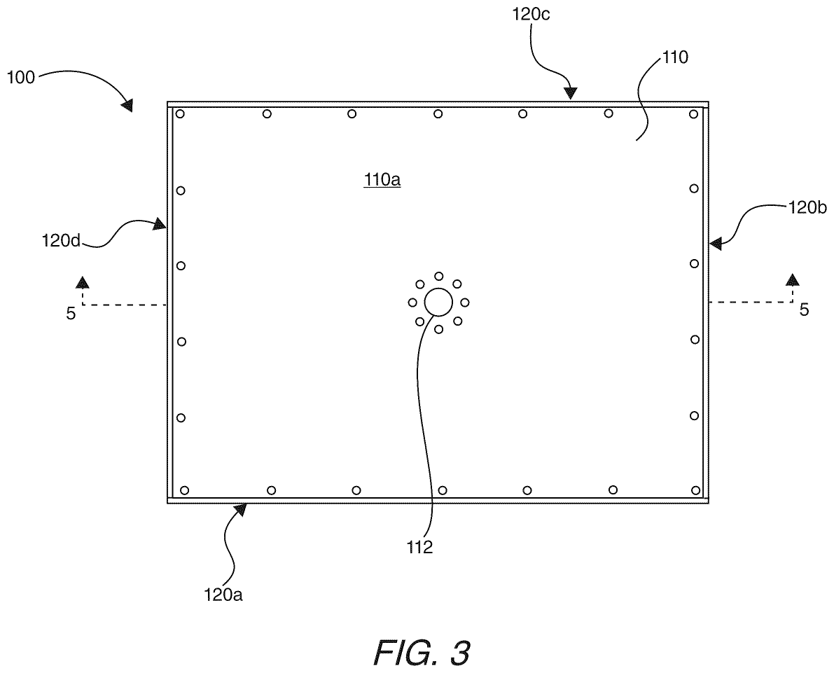

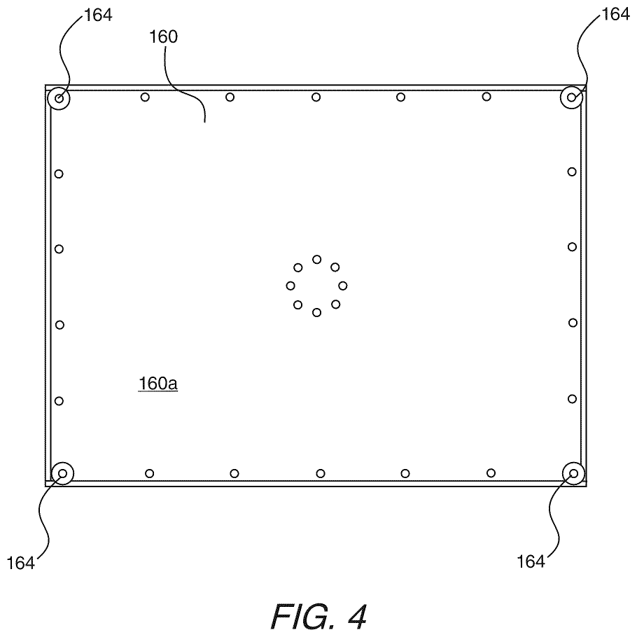

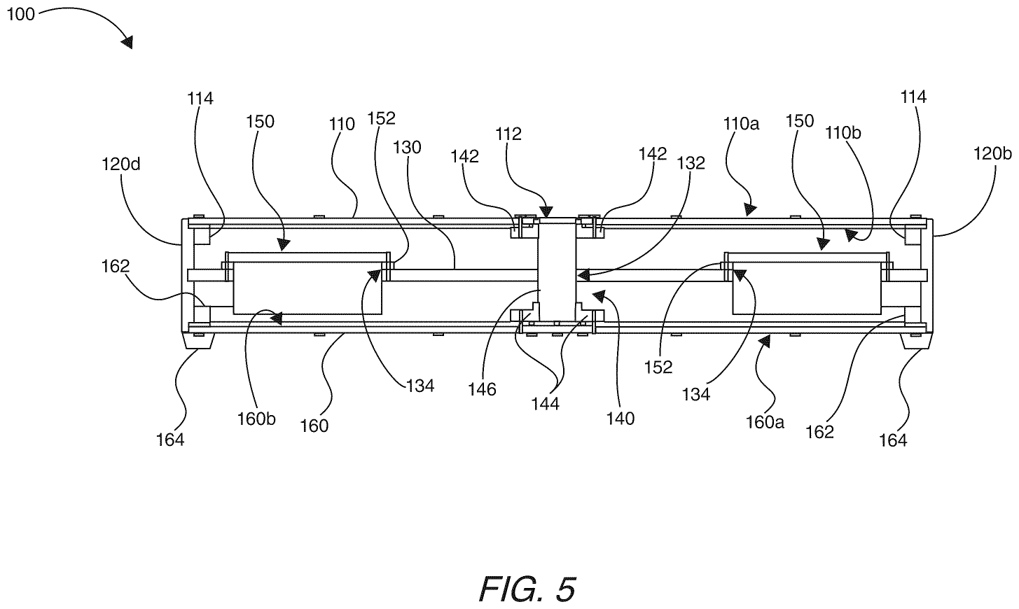

A system 100 according to the present invention is generally shown in FIGS. 1-5. The system 100 generally includes a top panel 110 and base panel 160 spaced by side panels 120a-d, and preferably housing a plurality of speakers 150 and optionally a chair mount 140 installed into a center panel 130. The top panel 110 and base panel 160 are preferably thin wooden sheets, which allow at least a small amount of flexibility of the panels, however other materials are also contemplated, including metals and hardened plastics. Further, the panels 110, 120, 160 are preferably configured in an arrangement such that the system 100 has a rectangular shape, where opposing side panels 120a-d are of equal lengths, widths, and heights. Alternatively, panels 120a-d may all be of equal lengths, widths, and heights, resulting in a system 100 of a substantially square shape. The panels 110, 120, 160 may be preferably fixed together using fasteners (e.g. nails) and/or joints (e.g. dovetail joints) to hold the panels 110, 120a-d, 130, and 160 in place and prevent system 100 failure. Once fixed together, the panels 110, 120a-d, 160 form a sealed system 100.

As stated above, the top 110 and base 160 panels are preferably made of thin, flexible wooden sheet. However, these panels 110, 160 are most preferably still thick enough that they are able to support the weight of a plurality of human adults. The top 110 also preferably includes an aperture 112 reaching from an outward surface 110a to an inward surface 110b. The top aperture 112 is preferably aligned with the chair mount 140 housed within the system 100, such that a chair 10 having a spindle or post 12 may be mounted to the system 100. This chair 10 may be a modified office chair, a gaming type chair, or some other kind of customized chair comprising a post 12. Alternatively, a common four-legged chair and/or stool may be placed or otherwise fastened or affixed on the top outward surface 110a during use of the system 100. Further, a series of supports 114 are preferably fixed to the top inward surface 110b to help distribute weight within the system 100.

Located within the bounds of the panels 110, 120a-d, 160 are preferably the chair mount 140, speakers 150 and power source 154, and center panel 130. Similar to the top 110 and base 160 panels, the center panel 130 is preferably a wooden sheet. However, the center panel 130 is preferably much thicker than the top 110 or base 160 panels, such that the center panel 130 is substantially rigid and inflexible. The center panel 130 is preferably situated equidistant between the top 110 and base 160 panels and fixed to the side panels 120a-d by fasteners and/or joints. This arrangement creates two separate sealed chambers within the system 100, one between the top panel 110 and the center panel 130 and another between the center panel 130 and the base panel 160. As sound waves bounce around the chamber between the center panel 130 and top panel 110, the top panel 110 vibrates and distorts, creating a unique physical and/or auditory experience for a user standing or sitting on the top panel 110.

The center panel 130 also preferably includes a series of its own apertures. Preferably located in the middle of the center panel 130 is a mounting aperture 132, which the chair mount 140 utilizes as explained below. Further, a plurality of speaker apertures 134 are cut through the center panel 130, which hold the speakers 150. The number of speaker apertures 134 are preferably equal to the number of speakers 150 in the system 100.

As explained above, a chair mount 140 may optionally be situated within the system 100 and may be used to bolt a chair having a post into the system 100. The chair mount 140 preferably consists of a top flange 142 and base flange 144 situated on either end of a central pipe 146. To hold the chair mount 140 in place, the top flange 142 is preferably fastened to the top panel 110, while the base flange 144 is preferably fastened to the base panel 160. Further, the central pipe 146 is preferably arranged to reach through the central panel mount aperture 132. This arrangement acts to secure the spindle or post 12 of a chair in place while the system 100 is in use. Almost any chair type having a spindle or post known in the art is compatible with the present invention, including office chairs.

As mentioned above, the system 100 preferably includes a plurality of speakers 150 powered by a power source 154. The speakers 150 may be conventional speakers, such as those available at electronics stores, which have a high frequency range. One or more 2-300 watt amplifiers are preferably used to power the speakers 150. Additionally, or alternatively, the speakers 150 may also include wired and/or wireless communication capabilities (i.e. Wifi and/or Bluetooth®) to connect directly to an audio-producing device, such as a phone or television. In installation into the system 100, the speakers 150 are preferably placed within the center panel speaker apertures 134. Each speaker 150 may also be preferably spaced from the center panel 130 surface by a spacer 152. While the present figures display a pair of speakers 150, it should be understood that embodiments wherein there are more than two speakers 150 and embodiments wherein only one speaker 150 is included within the system 100 are also contemplated. The power source 154 may be a power source known in the art, such as a one or more one-time use batteries, rechargeable batteries, or cord leading to a wall outlet to power the system 100.

The base panel 160 preferably acts as the bottom of the closed box system 100. Similar to the top panel 110, the base panel 160 is preferably affixed to the side panels 120 by fasteners and/or joints. Further, the base panel 160 comprises an inward surface 160b facing into the system 100, which the base flange 144 of the chair mount 140 is fastened to. The inward surface 160b may also include a plurality of supports 162 in a similar arrangement and for a similar purpose as the supports 114 for the top panel 110. Unlike the top panel 110, however, the base panel outward surface 160a preferably includes a series of feet 164, which stabilize the system 100 while it is at rest on a surface. The feet 164 are preferably made of rubber, which aids in preventing the system 100 from sliding across the ground while in use.

When the system 100 is in use, the speaker(s) 150 are preferably connected (via wired connection or wireless (Wi-Fi, Bluetooth®, etc.)) to an audio source, such as an amplifier, mobile device, television, etc. As the speaker(s) 150 emit sound waves, the resulting air pressure in the dual sealed chambers cause the top 110 and base 160 panels to flex, creating vibrations. For a user standing or sitting on the top panel 110 or sitting on a chair 10 supported by the top panel 110 (either mounted or not), the vibrations result in a physical sensation for the user. This creates a unique auditory experience that enhances the listening experience. The system 100 may be useful for musicians who like to “feel” the music. Similarly, the system 100 may be useful for deaf and hard-of-hearing users. Finally, other users may simply find that the system 100 enhances their music listening, television and/or movie watching, or video game playing experience.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A system for enhanced audio experiences comprising:
a housing comprising:
a top panel;
a base panel arranged parallel to the top panel; and
a plurality of side panels,
wherein the top panel and the bottom panel are spaced by and supported by the plurality of side panels;
a center panel within the housing, the center panel arranged parallel to the top and bottom panels and supported by the side panels; and
a sound system comprising at least one speaker supported by the center panel.

2. The system according to claim 1, wherein the sound system comprises more than one speaker in electronic communication with one another.

3. The system according to claim 2, wherein each speaker is spaced from the center panel by a spacer.

4. The system according to claim 1, wherein the sound system is in electronic communication with an audio source.

5. The system according to claim 4, wherein the electronic communication is wireless.

6. The system according to claim 5, wherein the wireless electronic communication comprises a WiFi connection.

7. The system according to claim 5, wherein the wireless electronic communication comprises radio communications.

8. The system according to claim 4, wherein the electronic communication is a wired connection.

9. The system according to claim 1, wherein the system further comprises a chair supported by the top panel.

10. The system according to claim 9, wherein the chair is affixed to the top panel.

11. The system according to claim 9, wherein the system further comprises a chair mount and the chair comprises a spindle, the chair mount being configured to receive and secure the spindle.

12. The system according to claim 1, the system further comprising a power source.

13. The system according to claim 12, wherein the power source comprises a plurality of batteries.

14. The system according to claim 13, wherein the batteries are rechargeable batteries.

15. The system according to claim 12, wherein the power source comprises a power cord configured to plug into a wall outlet.

16. The system according to claim 1, the system further comprising a plurality of feet supporting the bottom panel.

17. A method for enhancing audio experiences comprising the steps of:
providing:
a housing comprising:
a top panel, a bottom panel, and a plurality of side panels, the top panel and bottom panel being spaced by the plurality of side panels, the bottom panel supporting the side panels and the side panels supporting the top panel;
a center panel within the housing arranged parallel to the top and bottom panels; and
a sound system comprising at least one speaker supported by the center panel;
pairing, through electronic communication, an audio source to the sound system; and
playing audio through the sound system.

18. The method according to claim 17, wherein a user is supported by the top panel.

19. The method according to claim 17, wherein the user is sitting on the top panel.

20. The method according to claim 19, wherein the user is sitting on a chair supported by the top panel.
